(19) United States
(12) Patent Application Publication
(10) Pub. No.: US 2022/0036562 A1
(43) Pub. Date: Feb. 3, 2022

(54) VISION-BASED WORKING AREA BOUNDARY DETECTION SYSTEM AND METHOD, AND MACHINE EQUIPMENT

(71) Applicant: Bongos Robotics Shanghai Co., LTD, Yangpu District (CN)

(72) Inventors: Yifei WU, Yangpu District (CN); Wei ZHANG, Yangpu District (CN); Xinliang BAO, Yangpu District (CN)

(73) Assignee: Bongos Robotics Shanghai Co., LTD, Yangpu District (CN)

(21) Appl. No.: 17/309,406

(22) PCT Filed: Jan. 18, 2019
(86) PCT No.: PCT/CN2019/072304

§ 371 Date: May 25, 2021

(30) Foreign Application Priority Data
Nov. 27, 2018 (CN) 201811428294.2

(51) Int. Cl. G06T 7/12; G06K 9/00; G06T 7/90

(52) U.S. Cl. CPC G06T 7/12; G06K 9/00718; G06T 2207/10016; G06T 2207/20081; G06T 2207/20084; G06T 7/90

(57) ABSTRACT

The invention discloses a vision-based working area boundary detection system, method and machine equipment. When implementing the solution, we firstly train the constructed neural network model based on the training data set, extract and learn the features of the corresponding working area. Next, the neural network after training and learning is employed to perform real-time image semantic segmentation on the collected video images based on the extracted features, thereby perceiving the environment and identifying the boundaries of the working area. The solution provided by the present invention is based on neural network technology, and can efficiently identify the boundary of the working area through the extraction and learning of the features of the working area in the early stage, and has strong robustness to environmental perturbation such as lighting.

### TECHNICAL FIELD

The present invention relates to machine vision technology, in particular to a working area boundary detection technology based on machine vision.

### BACKGROUND

With the development and popularization of machine vision, more and more autonomous working robots employ machine vision to perceive the surrounding environment and working area, such as plant protection drones, logistics and warehousing robots, power inspection robots, factory security robots, lawn mowing robots, etc. Autonomous robots often drive out of specific working areas, causing risks and safety hazards to other areas. This is because existing technology cannot accurately detect the boundary of the working area in real time.

Color matching and shape segmentation are the existing main methods to detect the boundary of the working area through machine vision technology. However, these approaches are sensitive to environmental changes such as lighting, require expensive hardware support and have low recognition accuracy, as well as difficult to achieve real-time detection. So the performance of the autonomous robot is greatly reduced due to the low accuracy of the perception of the surrounding environment.

### BRIEF SUMMARY OF THE INVENTION

To solve the above problems, a high-precision working area boundary detection scheme is needed.

The invention proposes a vision-based system working area boundary detection system, and accordingly, further provides a detection method and a machine equipment equipped with the proposed detection scheme.

The detection system includes a processor and a computer-readable medium storing computer program. When the computer program is executed by the processor:

The constructed neural network model train and learn based on the training data set, extracting the features of the corresponding working area;

During the inference, the neural network performs real-time image semantic segmentation on the collected video images based on the extracted features, thereby perceiving the environment and identifying the boundaries of the working area.

Furthermore, the neural network model is composed of convolution layers, pooling layers, and an output layer. The convolution layers and pooling layers are stacked to extract image features. The output layer updates parameters during training and outputs the image segmentation result during inference.

Furthermore, the pooling layer performs statistics along with the row and column directions of the image and extracts the maximum value of N pixels as the statistical feature of the region. At the same time, the magnitude of data is reduced to one-Nth of the original.

Furthermore, the neural network also includes a dilated convolution layer modules formed by a number of dilated convolution layers in parallel and arranged after the pooling layer. The dilated convolution layer which insert holes into the original convolution layer, expanding the reception field of feature extraction and retaining the global information of the image.

Besides, an up-sampling layer is arranged in front of the output layer, aiming to raise the size of the reduced image and restore the detailed content of the image.

The vision-based method for the detection of the boundary of the working area provided in this invention comprises:

Constructing and training neural network model based on the training data set, extracting and learning the features of the corresponding working area.

The neural network after training performs real-time image semantic segmentation on the collected video images based on the extracted features of the working area, thereby perceiving the environment and identifying the boundaries of the working area.

Furthermore, acquiring pictures of real outdoor work scenes, pre-processing the pictures and segmenting pictures manually according to the category of the target object to form the training set;

Furthermore, training neural network model based on the training data set mainly comprises:

Initialization, determining the number of neural network layers and initializing the parameters of each layer of the network;

Input the images in training set into the initialized neural network for parameters calculation;

Comparing the output of the neural network with the image ground truth labels, computing the training error and updating the relevant parameters in the neural network model;

Repeating the above steps until the training error is minimum, the training of the neural network is completed.

Furthermore, in performing real-time image semantic segmentation on the collected video images identifying the boundaries of the working area, this detecting method comprises:

The trained neural network model performs feature extraction on the video images collected in real time;

The neural network model performs data statistics and size reduction on the extracted feature data;

The neural network model outputs segmented image result through model inference.

Furthermore, for each pixel in the input real time image, the probability of it belonging to each category in the training set is calculated and it is marked as the category with the highest probability, thus the segmented image is obtained after all pixels are marked.

Furthermore, because the same classification is denoted by the same color, the boundary line between the target classification color and other color blocks is exactly the boundary of the working area that needs to be detected.

This invention also provides a machine equipment equipped with the above boundary detection system.

The solution provided by the present invention is based on neural network machine vision technology, and can efficiently identify the boundary of the working area through the extraction and learning of the features of the working area in the early stage, and is robust to environmental changes such as lighting.

Besides, this invented compact neural network structure ensures real-time performance on the embedded platform, and is suitable to deploy on the outdoor mobile robot platforms, such as unmanned aerial vehicles, outdoor wheeled robots, etc.

### BRIEF DESCRIPTION OF THE DRAWINGS

The present invention will be further explained below in conjunction with the drawings and specific embodiments.

FIG. 1 is the schematic diagram of the neural network structure constructed in an example of the present invention;

FIG. 2 is an exemplary diagram of the original image obtained in an example of the present invention; and

FIG. 3 is the real-time output of the neural network modeling the example of the present invention.

### DETAILED DESCRIPTION OF THE PREFERRED EMBODIMENT

In order to make readers understand the technical methods, features, objectives and effects of the present invention more easily, we will further explain the present invention with figures below.

This scheme is based on a neural network technology to perform image semantic segmentation on the video images collected by the camera, thereby achieving an accurate perception of the environment and identifying the boundaries of the working area.

Starting from this principle, the corresponding neural network model are constructed, and real work scene pictures are collected to form the training data set and then use the training set to train the neural network, extracting the features of the working area.

In application, the deep neural network model after training performs real-time image semantic segmentation on the video images of the collected working environment based on the features of the working area extracted by training and learning, thereby perceiving the environment and identifying the boundary of the working area.

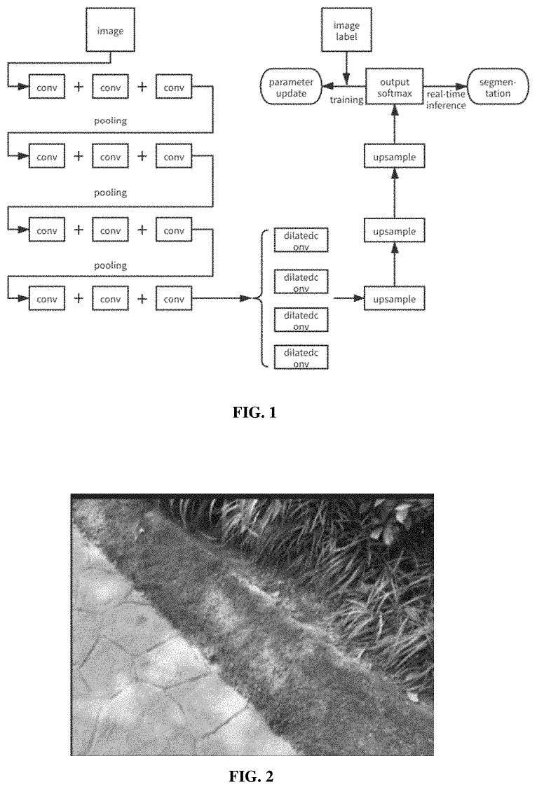

FIG. 1 shows an example of a neural network structure based on the above principles.

The neural network in this example is mainly composed of a multiple convolution layers, multiple pooling layers, and an output layer. The convolution layers and the pooling layers are stacked to complete image feature extraction. All layers update their parameters during the training stage. After that, the neural network outputs the image segmentation results during the inference stage.

The convolution layers convolve the input image multiple times. Each convolution layer has a convolution kernel of a specified size, such as 3×3, 5×5, extracting the image features with the same size as the convolution kernel. The extracted features include image color depth, texture features, contour features and edge features, etc.

The pooling layer performs statistics along with the row and column directions of the image and extracts the maximum value of N pixels as the statistical feature of the region. At the same time, the amount of data is reduced to one-Nth of the original. For example, the pooling layer in this solution performs statistics on every two pixels in the rows and columns direction of the image and extracts the maximum value of four pixels as the statistical feature of the area while reducing the data volume to ¼ of the original.

The multiple convolution layers and pooling layers in this invention maintain the high accuracy of the extraction of image features and greatly reduces the amount of calculation, allowing it applicable to embedded platforms that cannot support intensive matrix calculations.

The output layer calculates the probability that each pixel belongs to each category, updates the parameters in the training and learning stage, and outputs the segmented images in the real-time semantic segmentation stage.

For example, we can use the softmax function in the output layer:

$$\begin{matrix}{σ ( z )}_{j} = \frac{{e}^{{z}_{j}}}{{\sum }_{k = 1}^{K} {e}^{{z}_{k}}} ; & ( 1 ) \\ loss = - log {σ ( z )}_{j} ; & ( 2 )\end{matrix}$$

Here, K represents the total number of categories. zⱼ and zₖ are the values of the j-th and k-th categories calculated by the model.

Eq. (1) is the softmax function, which calculates the probability of the j-th category.

Eq. (2) is the loss function, and the model parameter values are updated through the back-propagation algorithm during the training process.

In the training and learning stage, compare the calculated probability with the image label and updates the model parameters with the loss value of Eq. (2); in the real-time semantic segmentation stage, each pixel is marked as the category with the maximum calculated probability and output the corresponding segmented image after all pixels in the image are marked.

Furthermore, we can modify the above neural network model to further improve the accuracy of segmented images.

We introduce a dilated convolution layer module formed by a number of dilated convolution layers in parallel and is arranged after the pooling layer, into the above neural network.

Unlike the traditional convolution layers that only extracts the features of adjacent elements, there is a gap of the same distance between the extracted elements in the dilated convolution kernel. For example, inserting zero values(holes) between adjacent elements in a 3×3 traditional convolution kernel will form a hollow convolution of the 3×3 convolution kernel, the effect of which is similar to the traditional 5×5 convolution but only 36% parameter operation.

The dilated convolution layer module presented in FIG. 1 has four parallel dilated convolution layers and the size of them is from small to large. The four stacked dilated convolutions expand the reception field, extract a wide range of image features with few parameters, and retain the global information of the image.

Besides, we also introduce an up-sampling process before the output layer of the neural network. In the up-sampling process, the size of the reduced image with abstract content is increased to restore the image details, and then the output layer outputs the segmented image.

The continuous up-sampling layer here decodes the abstract content of the image and restores the detailed content of the image. Each up-sampling layer expands the image along the row and column directions to increase the image size. For example, in this solution, the up-sampling layer in each layer expands the image by two times along the row and column directions so that the image size is increased by four times.

Since the multiple convolution layers and the pooling layers always lose the features of the image in the image processing process, the continuous up-sampling layer is introduced to increase the additional learning process to restore the lost feature information and the image details. At the same time, the image after the up-sampling has the same size as the original one, allowing more accurate segmentation results and realizing the end-to-end output.

In applications, the above neural network can be stored in a computer-readable medium in the form of a computer program and be invoked and executed by a processor to realize the above-mentioned functions and form a corresponding working system.

In addition, since the calculation amount and complexity of the neural network are greatly reduced, the working system can be well adapted to embedded platforms that cannot support excessive matrix calculations (such as drones, outdoor wheeled robots, etc.), and the working system operating on the embedded platform can intelligently identify the surrounding environment and detect the working area, which ensures the detection accuracy and real-time effect.

In summary, the process of sensing the environment and identifying the boundary of the working area boundary detection system based on the neural network can be divided into the following steps.

(1) Obtain training data

The training set is formed by acquiring images of the real outdoor work scene, pre-processing the pictures, and segmenting the pictures according to the target object category (for example, grass, road, mud, shrub, etc.).

The number and resolution of training images have a great influence on the results of image detection. So, firstly, we perform light normalization on images with strong lighting changes to reduce the influence of light. Then, all pictures are cropped to the same size and color the images according to the target object category, forming the label images. The training set consists of the original images and the label images.

(2) Train neural network model

The training process includes initialization, iterative update of network parameters and network output. More details are below:

Initialization, determining the number of neural network layers and initializing the parameters of each layer of the network;

Putting the images in training set into the initialized neural network for parameters calculation;

Comparing the output of the neural network with the image ground truth labels, calculating the training error and updating the relevant parameters in the neural network model;

Repeating the above steps until the training error is minimum, the training of the neural network is completed.

(3) Deploy the deep neural network model.

Deploying the trained model into the environment, inputting the working environment video images captured by the camera into the trained deep neural network model to detect the boundary of the working area.

The deep neural network model performs image semantic segmentation on the video images collected in real time to identify the boundary of the working area, and mainly comprises,

(3-1) The deep neural network model performs parameter calculations, extracting image features;

(3-2) The deep neural network model performs data statistics and size reduction on the extracted feature data. Data statistics are performed every two pixels along the rows and columns of the image and take the maximum value of four pixels as the statistical feature of the area. In this way, the data size is also reduced to ¼ of the original; and

(3-3) The deep neural network model outputs segmented images through model inference. For each pixel in the real-time input image, the probability of it belonging to each category in the training set is calculated and it is marked as the category with the highest probability. The segmented image is obtained after all pixels are masked. Because the same color denotes the same classification, the boundary line between the target classification color and other color blocks is exactly the boundary of the working area that needs to be detected.

On basis of above, to improve the accuracy of segmentation, we introduce the dilated convolution into the model to facilitate feature extraction with fewer parameters, expanding the field of feature extraction and retaining the global information of the image.

Also, an up-sampling layer is arranged in front of the output layer, aiming to raise the size of the reduced image and restore the detailed information of the image.

In the following, we will take embedded platform running this working system as a specific application example to illustrate the process of intelligently identifying the surrounding environment and detecting the working area.

The vision-based working area boundary detection equipment given in this example mainly includes a digital camera module, an embedded processor chip module, and a computer storage module.

The computer storage module stores the machine vision-based working area boundary detection system program. The embedded processor chip module in the detection device completes the working area boundary detection by running the detection system program in the computer storage module.

The objects that need to be recognized are divided into 4 categories: sidewalk, lawn, soil, and shrubs. The embedded processor chip module runs the detection system program and trains the neural network in the system with training data set so that the system has the ability to identify objects autonomously.

When the working system is running, the digital camera module on the detection equipment collects the video of the surrounding environment in real-time and converts it into images to form the original images (as shown in FIG. 2).

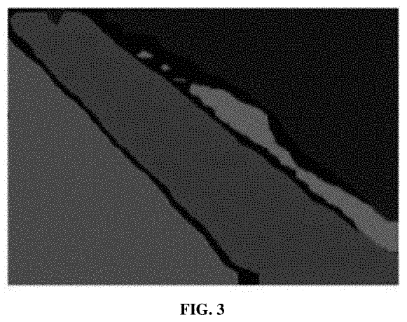

Then, feed the original images into the trained deep neural network in real time, and perform parameter calculations through the convolution layer and pooling layer to extract features. The output layer calculates the probability that each pixel belongs to each category. We can obtain the segmented images shown in FIG. 3 after each pixel is marked as the category with the highest probability. Since the same color denotes the same classification, the boundary between the target classification color and other color blocks is exactly the boundary of the working area that needs to be detected.

From FIG. 3, we can see that the proposed working system can distinguish target categories accurately (pink represents sidewalk, red represents lawn, green represents soil, and blue represents shrubs) and identify the boundary of the working area that needs to be detected.

The detection method proposed in the present invention, as well as the specific system unit, is a pure software architecture and can be deployed on physical media such as hard disks, optical discs, or any electronic devices (such as smartphones, computers readable storage media) through codes. When the machine loads and executes the program (such as the smartphone), the machine will become a device to implement the present invention.

The method and device of the present invention can also be transmitted in the form of program code through some transmission media, such as cable, optical fiber. When the program code is received, loaded and executed by a machine (such as a smartphone), the machine becomes the device for carrying out this invention.

Till now, we have described the basic principles, main features and advantages of our invention. Note that the present invention is not limited by the above-mentioned example which is only presented to illustrate the principles of the present invention. Without departing from the spirit and scope of the present invention, the present invention will have various modifications and improvements, which also fall within the scope of the claimed invention. The appended claims and their equivalents define the scope of protection claimed by the present invention.

1. A vision-based working area boundaries detection system including a processor and a computer-readable medium storing a computer program; wherein when the computer program is executed by the processor:
a constructed neural network model performs autonomous training and learning based on a training data set, extracts and learns features of a corresponding working area;
the neural network after training performs real-time image semantic segmentation on collected video images based on the extracted features extracted by the training and learning, thereby perceiving the environment and identifying boundaries of the working area.

2. The vision-based detection system of a working area boundary according to claim 1, wherein the neural network model in the vision-based detection system includes multiple convolution layers, multiple pooling layers, and an output layer; the convolution layers and the pooling layers are stacked to extract image features; all layers update their parameters during a training phase, and outputs the image real time segmentation result during an inference phase.

3. The vision-based detection system of a working area boundary according to claim 2, wherein the pooling layers performs statistics and data dimensionality reduction on the output features of the convolutional layers, along the direction of the image rows and columns; the statistics are carried out, and the maximum value of N pixels is extracted as the statistical characteristics of the area, and the data volume is reduced to one-Nth of the original.

4. The vision-based detection system of a working area boundary according to claim 2, wherein the neural network model also includes a dilated convolution layer module, which is formed by a number of dilated convolution layers in parallel and is arranged after the pooling layer; the dilated convolution layer which insert holes into the original convolution layer, expanding a receptive field of feature extraction and retaining a global information of the image.

5. The vision-based detection system of a working area boundary according to claim 4, wherein the neural network model includes up-sampling layers, which are arranged in front of the output layer, aiming at raising a size of the reduced image and restoring the detailed content of the image.

6. A vision-based working area boundary detection method wherein:
a constructed neural network model performs autonomous training and learning based on a training data set, and extracts features of a corresponding working area;
after a training and learning phase, the system performs real-time image semantic segmentation on collected video images based on the extracted features, thereby perceiving the environment and identifying boundaries of the working area.

7. The method for detecting a vision-based work area boundary according to claim 6, wherein the training data is formed by acquiring pictures of real outdoor working scenes, pre-processing the pictures and labeling pictures manually according to the category of the target object.

8. The method for detecting a vision-based work area boundary according to claim 6, wherein the neural network model is trained based on training data set, including
initialization, determine a number of layers and initial parameters of each layer;
feed the images in the training set into an initialized neural network model for parameter calculation;
compare output of neural network with the image label, calculate the error and update the values of the neural network parameters;
repeat the above steps until the training error is minimum, then complete training phase.

9. The method for detecting a vision-based work area boundary according to claim 6, wherein the method includes:
the trained deep neural network model performs feature extraction on the video images collected in real time;
the deep neural network model performs data statistics and dimensionality reduction on the extracted feature data;
the deep neural network model outputs image segmentation images through model inference.

10. The method for detecting a vision-based work area boundary according to claim 9, when the deep neural network model performs model inference, the probability of each pixel in the real-time input image belonging to each category in the training set is calculated and each pixel is marked as the category with the highest probability; the segmented image is obtained after all pixels are labeled.

11. The method for detecting a vision-based work area boundary according to claim 9, when the deep neural network model performs model inference to obtain segmented images, the same color denotes the same classification; in the segmented image, the boundary line between the target classification color and other color blocks is exactly the working area that needs to be detected.

12. A vision-based working area boundary detection machine is equipped with the above vision-based detection system for the boundary of the working area.
